(19) United States
(12) Patent Application Publication
(10) Pub. No.: US 2018/0012258 A1
(43) Pub. Date: Jan. 11, 2018

(54) NETWORKED ADVERTISEMENT DISTRIBUTION AND COMPLIANCE

(71) Applicant: Dealer Teamwork, LLC, Eden Prairie, MN (US)

(72) Inventors: Patrick Walker, East Bridgewater, MA (US); Dan Mondello, Chelmsford, MA (US); Katherine R. Donovan, Chaska, MN (US); Sean Stapleton, Carver, MN (US); Eric Miltsch, Henrietta, NY (US); John M. Dahl, Plymouth, MN (US)

(21) Appl. No.: 15/641,891

(22) Filed: Jul. 5, 2017

Related U.S. Application Data
(60) Provisional application No. 62/358,349, filed on Jul. 5, 2016.

(51) Int. Cl. G06Q 30/02

(52) U.S. Cl. CPC G06Q 30/0265; G06Q 30/0277

(57) ABSTRACT

A vehicle advertising system comprises a processor configured to perform operations in response to instructions from a predefined instruction set, a memory, and an advertisement module comprising instructions selected from the instruction set. The instructions when executed on the processor are operable to receive identification and financing information regarding a specific vehicle for sale, to generate a first advertisement formatted for presentation in a search engine result listing based on at least the received identification information and the received financing information, to generate a second advertisement formatted for presentation on a vehicle dealer website landing page associated with the first advertisement and based on at least the received identification information and the received financing information, and to provide a predicted effectiveness score on at least one of the first advertisement and the second advertisement before publication of the at least one advertisement.

This application claims the benefit of U.S. Provisional Application No. 62/358,349 filed Jul. 5, 2016, the contents of which are herein incorporated by reference.

### FIELD

The invention relates generally to networked vehicle advertising, and more specifically to networked advertisement distribution and compliance.

### BACKGROUND

Before consumers commonly used the Internet, purchasing a new vehicle typically involved seeing vehicle advertisements on television or a magazine, visiting a few dealers to check out vehicles of interest, deciding on a vehicle, and negotiating for the best price with one or more of the dealers visited. Dealer advertising to their local markets using television, radio, and newspaper ads would rarely target particular segments of the population or include specific details regarding financing or other purchase parameters that would not appeal to a general population, or risked spending a significant amount of money to advertise to an audience that largely did not qualify for the offer presented. Further, many states require that an advertisement for a specific vehicle or for a specific deal be made available to customers exactly as advertised, which made it inefficient to advertise specific vehicles that may be quickly sold or deals that may not apply to many customers who hear the advertisement.

With the Internet providing an ever-increasing amount of information to a consumer's smartphone or computer, a typical car buyer today may research cars using a variety of dealer, manufacturer, review, or other websites. They may also see advertisements and financing offers that are somewhat tailored to their online environment, such as seeing discounts for new graduates on a university website or through targeted mailings. Still, vehicle advertisements on dealer websites or vehicle sale aggregation sites are often vague or general, so as not to apply to a specific vehicle that may be sold or a purchaser who may represent only a small portion of the population. Other advertisements, such as on vehicle sale aggregation websites, may include more detailed information but are relevant only as long as a particular vehicle remains available.

Because vehicle advertising represents a significant portion of a dealer's budget, it is in the dealer's interest to present offers for cars that are available, and for which the user qualifies or at least has some interest. This prevents the dealer from spending money on advertisements that are not reaching the intended audience or for a car that is not available for sale, and reduces the chances of landing afoul of laws requiring that advertisements be presented to those who qualify for the offers contained in the advertisement or only for specific vehicles that are still for sale under the terms presented in the advertisement. But, the time and expense of presenting different ads to different people is immense, and replacing an advertisement with a new advertisement each time a vehicle is sold is also time-consuming and expensive. It is therefore desirable to provide vehicle advertising that manages presentation of offers, specials, and particular vehicles in a way that is cost and time efficient, and protects the dealer from running afoul of vehicle advertising regulations.

### SUMMARY

One example embodiment comprises a vehicle advertising system including a processor configured to perform operations in response to instructions from a predefined instruction set, a memory, and an advertisement module comprising instructions selected from the instruction set. The instructions when executed on the processor are operable to receive identification and financing information regarding a specific vehicle for sale, to generate a first advertisement formatted for presentation in a search engine result listing based on at least the received identification information and the received financing information, to generate a second advertisement formatted for presentation on a vehicle dealer website landing page associated with the first advertisement and based on at least the received identification information and the received financing information,

In a further example, the instruction when executed are further operable to provide a predicted effectiveness score on at least one of the first advertisement and the second advertisement before publication of the at least one advertisement.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows an example online vehicle advertising system.

FIG. 2 shows an advertising creation module graphical user interface, as may be presented by an advertising module to the user of a dealer computer system.

FIG. 3 shows a vehicle special editing graphical user interface page, which the dealer uses to enter additional information regarding the new vehicle special.

FIG. 4 shows the vehicle special editing graphical user interface page of FIG. 3, with additional vehicle offer information provided.

FIG. 5 shows a dealer landing page graphical user interface screen, which a dealer uses to create and preview a landing page generated as a result of entered vehicle information.

FIG. 6 shows a dealer Google Adwords graphical user interface screen, showing three different Google Adwords advertisements that have been automatically generated.

FIG. 7 is a dealer Google Adwords graphical user interface screen in which disclaimer information is provided, improving the specials quality score.

FIG. 8 is a specials quality score graphical user interface screen, which a dealer uses to provide additional information to improve the quality score of the special.

FIG. 9 is a screen image showing shows various specials the dealer has entered.

FIG. 10 shows a pages editor graphical user interface, which a dealer uses to edit a model page on the dealer website.

FIG. 11 is a flowchart, illustrating a method of presenting customer-specific dynamic vehicle advertising to a user.

FIG. 12 shows an example computerized online advertising sales system.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations are explicitly contemplated to be within the scope of the examples presented here. The following detailed description does not, therefore, limit the scope of what is claimed.

Vehicle advertising has changed from a model based on radio, television, and newspaper advertising to an environment in which purchasers rely primarily on online or networked services to research and find vehicles for sale. A typical user may see advertising for vehicles on social media sites such as Facebook or Tinder, on news sites or aggregators such as CNN.com or a local news site, or as a banner ad presented by Google or another ad provider. The user's interest drives the user to visit a vehicle manufacturer's website, where they can research comparable vehicles, trim levels, options, and other features. Finally, a user searches dealer websites or vehicle advertising aggregation websites to find a vehicle close by that matches the desired features, and visits a dealership to negotiate purchase of the vehicle.

Negotiating price and other terms of a vehicle purchase often takes different forms depending on the needs and constraints of the purchaser. A wealthy buyer may not care about payments, but may simply want the best price available, whereas a buyer with financial constraints may be focused more on monthly payment or special offers for recent graduates and the like. Determining what offers may be available to various buyers and ensuring that they are provided information regarding purchase terms that are of most interest to them is a difficult task, and typically costs an automotive dealer $400 or more in advertising and marketing per vehicle sold.

It is therefore in the dealer's best interest to determine a potential buyer's interests and qualifications as efficiently as possible, and to present them directly with the information most relevant to their set of constraints or interests. The dealer can thereby reduce spending on advertisements that are not reaching the right customers or on advertisements directed to a specific customer that are not tailored to the customer's interests. The dealer will also desirably avoid continuing to advertise a car that has already been sold, thereby reducing the advertising dollars spent on the already-sold vehicle while reducing the chances of landing afoul of laws requiring that advertisements for specific vehicles be presented only for vehicles that are still for sale under the terms presented in the advertisement.

Some examples described herein therefore provide vehicle advertising that manages presentation of offers, specials, and particular vehicles in a way that is cost and time efficient, and protects the dealer from running afoul of vehicle advertising regulations. This is achieved in a more detailed example by using information about a user such as the user's click path, soft-pull credit history, or search terms to present the user with one or more advertisements tailored to the user's vehicle purchasing profile. The advertisements include Google ads, dealer website advertisements, and email campaign advertisements, and contain content based on the information about the specific user.

In a further example, advertisements are presented via a third-party advertising service, which provides an advertisement scoring tool operable to provide a predicted effectiveness score of an advertisement for a vehicle before publication, based at least in part on whether the advertisement includes information that is relevant to a typical range of buyers and Google search queries for the vehicle. In a more detailed example, the advertisement scoring tool prompts a dealer to provide additional information to improve the predicted score of a vehicle advertisement that has a predicted score below a certain threshold, such as by providing price, payment, sales terms, lease terms, percent off, or other such information regarding offering the vehicle for sale. The third-party advertising service in another embodiment provides a landing page having one or more specific offers tailored to the user's buyer profile, such as by using the search history, click history, or soft-pull credit history of the buyer. The landing page presented in response to the user finding the dealer's website, such as through a search engine, will therefore be significantly more relevant to the user than a generic landing page, and will reduce advertising cost and result in more effective communication of relevant vehicle offers to the user.

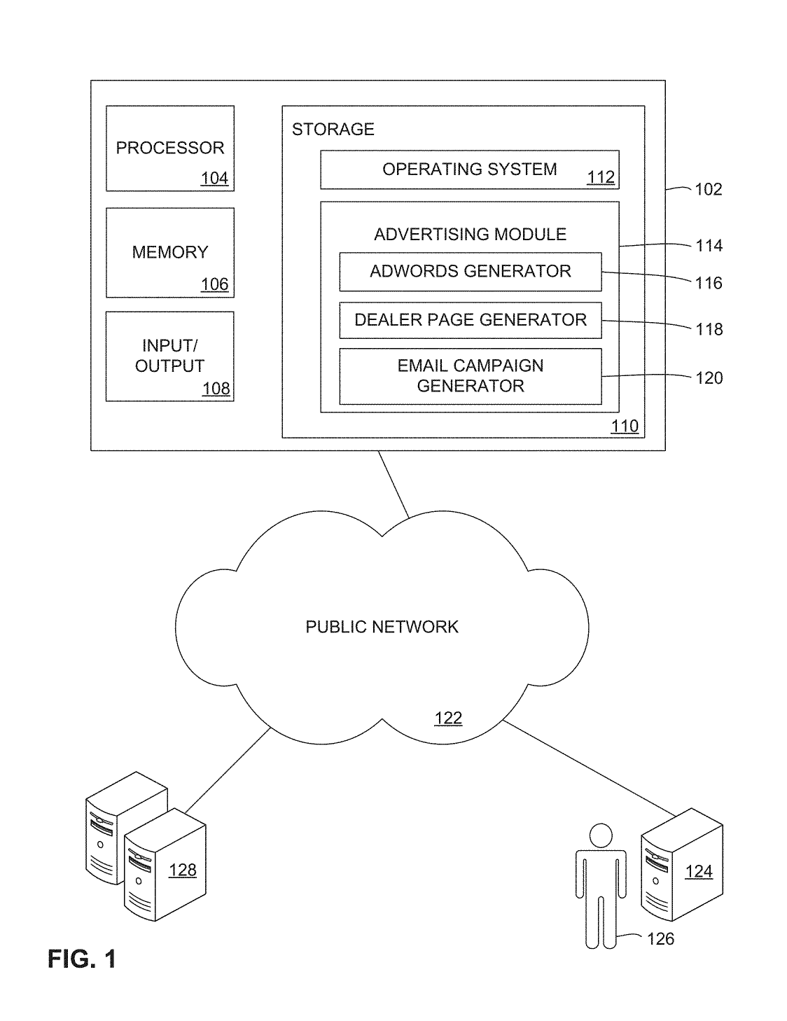

FIG. 1 shows an example online vehicle advertising system. Here, a computerized online vehicle advertising system 102 comprises various computer components, such as a processor 104 that is operable to execute program instructions to implement various functions of the online vehicle advertising system. A memory 106 stores program instructions and other information during operation of the computer, and input/output 108 provides for communication with users and with other computer systems to perform the various functions described herein.

Storage 110, such as a hard disk drive, solid state storage device, or other suitable storage stores program instructions and other information, including an operating system 112 that is operable to manage various functions of the computer and to provide for execution of various programs and services. Storage 110 also stores program instructions to implement advertising module 114, as well as associated data needed to perform various vehicle advertising tasks such as Google Adwords advertisement generator 116, dealer page advertisement generator 118, and email campaign advertisement generator 120.

The online vehicle advertising system 102 is linked via a public network such as the Internet 122 to one or more user computer systems 124, which user 126 uses to search for a vehicle to purchase. One or more dealer servers 128 provide information such as dealer inventory, and host a dealer website including information regarding the vehicles which the dealer has for sale. Servers connected to public network 122 also include various search engines, such as Google search which provides for Google Adwords advertisements presented in-line with search results.

In operation, a vehicle dealer uses their servers 128 or other computers to interact with online vehicle advertising system 102 to generate a vehicle advertisement for a vehicle for sale. They may specify a certain vehicle having certain options or packages, and include specific offers for the vehicle that can be presented to various users, such as discount, percentage rate, monthly lease, no money down payment, monthly payment, or other such information that a user can use to determine desirability of the dealer's offer for the vehicle. The advertising module 114 provides a graphical user interface and other tools for a dealer to enter information that is desirable in presenting such advertising offers to users, and implements a tool that provides a predicted effectiveness score of the advertisement resulting from information the dealer has supplied or elected. The advertising module 114 in a further example prompts the dealer to enter more information if the predicted effectiveness score is lower than a desired threshold, such as by requesting one or more specific things that will improve the predicted effectiveness score to the desired level.

The advertising module 114's Google Adwords advertising generator is operable to use this information the dealer has provided, along with knowledge of user response to various advertising presentations from historical data, to generate one or more Google Adwords advertisements for the dealer's vehicle that are tailored to specific offers, such as no money down, monthly payment, or other commonly searched purchasing criteria. The advertising module also creates a dealer landing page and/or vehicle advertising tile for the dealer's website hosted by a dealer server 128, such that the dealer's server will link to and display an advertisement provided by dealer advertisement page generator 118 when a user visits a certain page or pages on the dealer's website. Similarly, an email advertising campaign generator 120 uses the information he dealer has provided to generate one or more advertisements for a vehicle offered for sale that can be sent to potential customers as part of an email campaign, which in a further example are tailored to particular users based on knowledge of that user's interest in certain vehicles, certain offers for sale, and the like. A typical dealer may therefore have Google Adwords advertising and dealer landing page advertising published in hopes of attracting new customers, and may use email campaigns to target past customers or others known to the dealer who may be interested in purchasing a new vehicle.

A user 126 uses a computer system 124, such as a smartphone, personal computer, or the like, to search for a vehicle for sale. The inquiry will typically include the vehicle the user desires, and optionally may include a location, such as a state or city, and particular deal terms of interest to the buyer such as “lease,” “no money down,” or “military discount.” The search results will typically include a listing of web pages relevant to the user's search terms, such as provided by Google and other search engines, possibly along with one or more paid advertisements relevant to the search results such as a Google Adwords advertisement. The user will scan the search results, and find both Google Adwords advertisements submitted to the Google Adwords program through the advertising module 114's Adwords advertising generator 116, and dealer website pages for dealers near the user that include an offer for a vehicle that closely matches the user's search criteria. Because search results are ranked in order of relevance to the user's search terms and other information about the user (such as geography, interests, etc.), the Adwords advertising generator 116 and the dealer advertising page generator 118 will desirably both include information relevant to the user's likely search terms when searching for a vehicle to buy and relevant t′ the user's buyer profile. Other advertising or search venues, such as Facebook, will similarly include context-specific advertisements such as Adwords advertisements, configured to present vehicles and vehicle purchase deals to users based on such information.

When the user 126 selects a Google Adwords advertisement generated by Adwords advertisement generator 116, or clicks a search result link pointing to a dealer's website based on a dealer advertisement generated by dealer advertisement page generator 118, the user is directed to the dealer's webpage, hosted by a dealer server 128. The advertisement presented to the user is not hosted on the dealer's server 128, but is served in real-time from the online vehicle advertising system 102's dealer advertising page generator 118. This ensures that the advertisement provided to the user is current, and reflects a vehicle offer tailored to the user's particular buyer profile, click history, search path, and the like. It further ensures that the advertisement presented to the user from the dealer website's landing page contains an offer for a vehicle that the dealer still has in stock, as advertisements generated by the advertising module 114 are updated frequently with information from the dealer's inventory database from a dealer server 128. The advertisement in a further example is also tailored based on other factors, such as the specific requirements of the manufacturer, state, or dealer involved in the vehicle sales transaction.

Consumer research indicates that approximately 95% of vehicle purchasers buy the most they can afford, such that a soft pull of a user's credit information or other indicia of a user's financial status can be a significant help in tailoring an advertisement to a particular user. The advertisements generated by advertising module 114 may also have a different focus depending on the known or predicted demographics of the user, such as advertising a vehicle as “green” for liberals or as prestigious for conservatives. Advertisements may also vary based on the price of the vehicle advertised relative to the anticipated budget of the user, such as advertising a vehicle below the user's expected budget as a good value or advertising a vehicle above a user's budget as sporty or luxurious.

The advertising module 114 is also operable in some examples to identify someone looking outside of their expected profile, such as a user shopping for vehicles they have little hope of ever affording or a user shopping for a vehicle well below their anticipated price range. If a user having an Accord or Camry budget is searching for Ferraris and Lamborghinis, the advertising module may decline to pay to advertise available exotic cars to the user such as through Google Adwords or the like, thereby reducing the advertising cost to sell such cars to actual buyers. Similarly, a user shopping for a vehicle that is significantly cheaper than their predicted budget might indicate that the user is shopping for a secondary vehicle or for a kid, and advertising directed toward the user for such vehicles may be modified to focus on reliability, safety, and other such aspects.

These examples illustrates how tailoring an advertisement such as a Google Adwords advertisement can be used to target a user desiring a particular type of deal for a particular vehicle based on knowledge of the user's interests, and how use of a targeted advertisement for a vehicle offered for sale rather than a generic vehicle landing page on the dealer's website can be used to better engage a user wanting to purchase a vehicle.

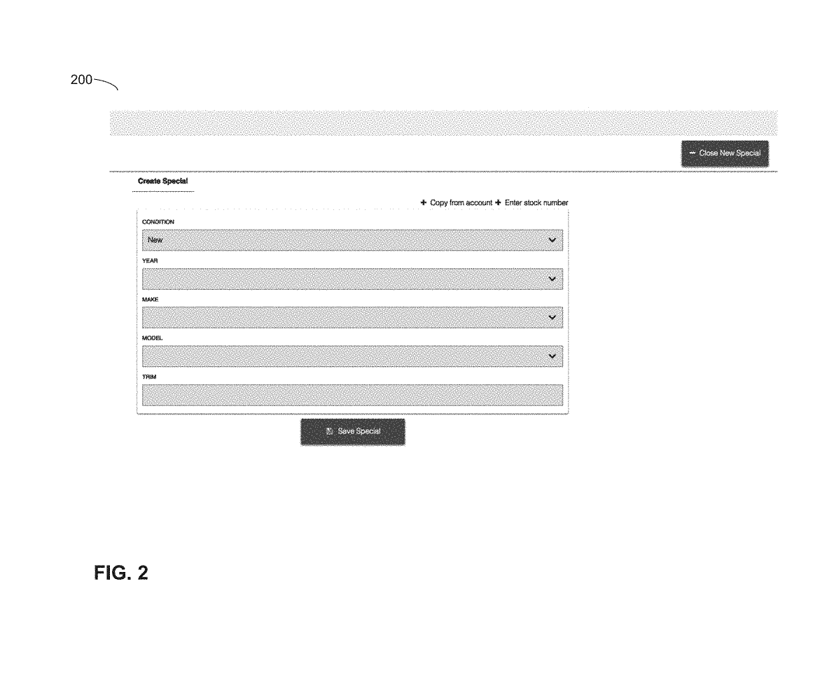

FIG. 2 shows an advertising creation module graphical user interface, as may be presented by advertising module 114 to the user of a dealer computer system 128. At 200, the dealer is prompted to enter information regarding a vehicle for sale, by entering whether the vehicle is new or used, entering the year, make, model, and trim level of the vehicle. Alternatively, the user can copy vehicle information from their dealer account, or can enter a stock number for the vehicle so that the relevant vehicle information can be pulled from the dealer's inventory tracking system. When this basic vehicle information is entered, the dealer clicks on the “save special” button, saving the entered data as a newly featured special or offer to be presented in various advertising.

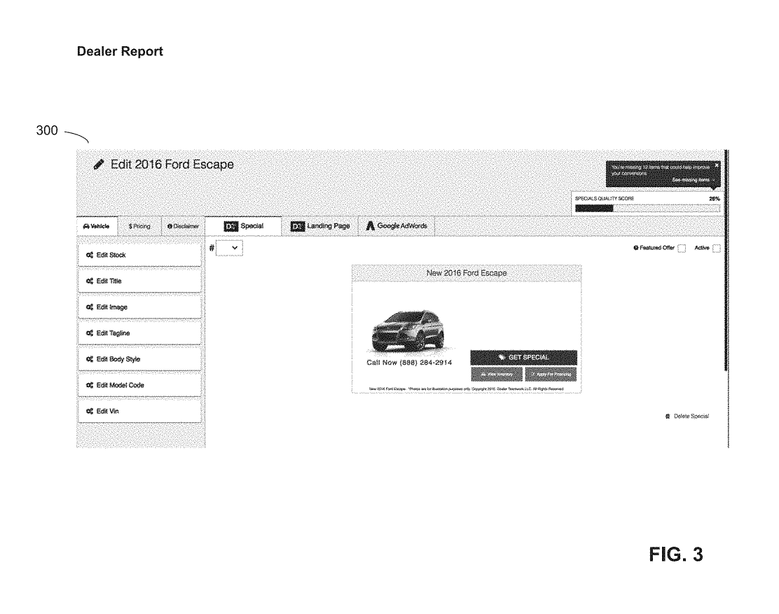

FIG. 3 shows a vehicle special editing graphical user interface page, which the dealer uses to enter additional information regarding the new vehicle special. At 300, the dealer can edit different categories of information, such as vehicle details, pricing details, and a disclaimer. The vehicle details in this example include elements such as the stock number, title of an advertisement, image, tagline, body style, model code, and Vehicle Identification Number or VIN. Similarly, the dealer can select the pricing tab along the top menu bar to enter information such as interest rate, discount, monthly payment, zero money down monthly payment, lease, and other such information. The dealer can also click the disclaimer tab to enter disclaimer information as preferred by the dealer, such as may be required by the dealer's state of business, dealer network, manufacturer, or by other criteria.

The special presented in the window on the right side of the screen image shown at 300 shows a box with the special displayed, based on the information entered using the menus on the left side of the window. At the top right, a quality score is also presented, based on a predicted effectiveness or quality of the special displayed, along with an indication that there are 12 missing data items that could help improve the relatively low predicted effectiveness rating. The predicted effectiveness or specials quality score is based on searchability of the special or advertisement, such that an advertisement or special containing enough information to appear high in search results for users looking for a specific vehicle and terms will score higher. For example, a person searching for “Ford Escape” may still be researching vehicles, but a person searching for “2016 Ford Escape zero down lease” is likely ready to buy a vehicle and should be a high priority target for advertising and search results. Example information that may contribute to searchability include in some examples make, model, trim, tagline, model code, vehicle identification number (VIN), disclaimer, manufacturer's suggested retail price (MSRP), savings from MSRP, lease offer, zero down offer, annual percentage rate (APR) offer, and savings from previous price.

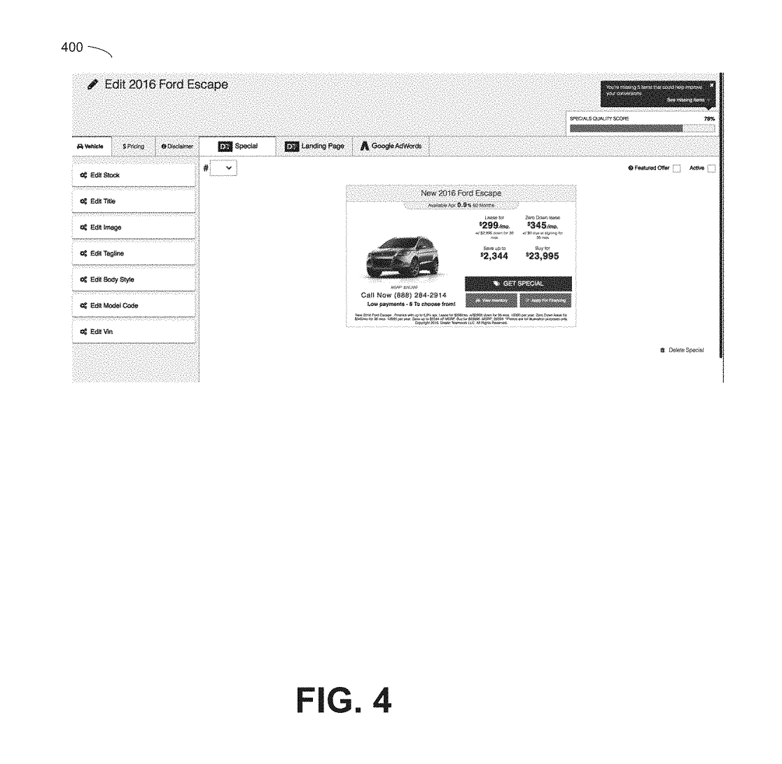

FIG. 4 shows the vehicle special editing graphical user interface page of FIG. 3, with additional vehicle offer information provided. As shown in the screen image at 400, the predicted effectiveness reflected by the specials quality score displayed in the upper right is improved from 28% to 78%, with the addition of seven pieces of information regarding the special. The additional information is also reflected in the vehicle special displayed in the window on the right side of the screen, which now reflects a cash purchase price, a savings off Manufacturer's Suggested Retail Price (MSRP), a zero down lease offer, and a lease offer with a down payment. It also reflects an annual percentage rate offered for financing over 60 months, and that eight different vehicles meeting the advertised criteria are available. The disclaimer also includes additional information regarding the various lease and sale offers presented in the special, and the MSRP of the vehicle is provided for reference. Although the specials quality score of 78% indicates that there are still five pieces of information that could help improve conversions from ad views into sales, the special advertisement of FIG. 4 reflects significantly more information than the basic special advertisement of FIG. 3, and is much more likely to result in a customer purchasing a vehicle as a result of viewing the special.

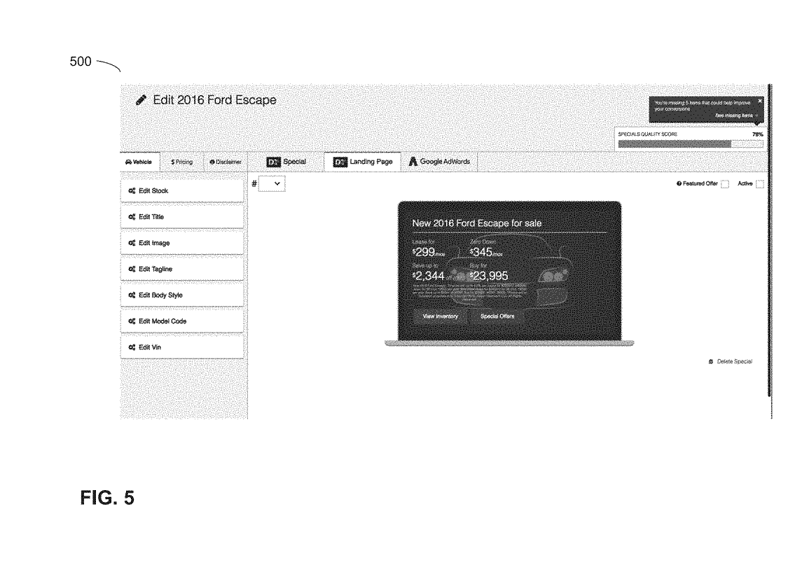

FIG. 5 shows a dealer landing page graphical user interface screen, which a dealer uses to create and preview a landing page generated as a result of vehicle information entered using the menu at the left side of the screen. At 500, the same information entered to generate the special of FIG. 4 is used to generate a landing page for a dealer's website, such as may be presented to a user when clicking a Google Adwords advertisement provided by the dealer or when finding the dealer's vehicle offers through search engine results. Much as with the special window of FIG. 4, the information provided is used to render a landing page, and a specials quality score predicts the effectiveness of the landing page based on the completeness of information regarding the vehicle and various offers or sale/lease terms for the vehicle. Here, the window on the lower right illustrates how the vehicle landing page will look to a user, using a simulated laptop computer screen.

Because the landing page of FIG. 5 has information such as offers for a specific vehicle at specific terms presented to the user, the user is significantly more likely to purchase a vehicle from the dealer presenting the landing page than from a dealer that simply has generic make and model pages on their website. For this reason, landing pages in a further example are further tailored to a particular user based on click path, search history, soft-pull credit profile, or other knowledge of the user's preferences. Because the landing page is served by the advertising system 102 rather than the dealer's server 128, the landing page can be configured differently for each user, in real-time.

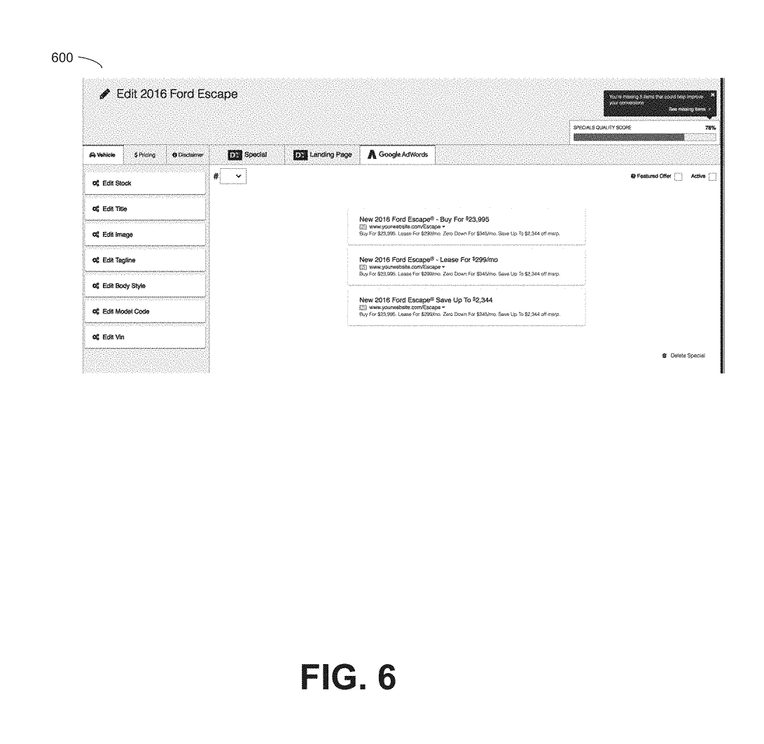

FIG. 6 shows a dealer Google Adwords graphical user interface screen, showing three different Google Adwords advertisements that have been automatically generated using the information provided using the menus on the left hand side of the screen. Here, the same information provided in the examples of FIGS. 4 and 5 is used to generate the Google Adwords advertisements, which are shown in the window on the lower right of the screen. The advertisements each focus on a different offer based on the information the dealer has entered about the vehicle, including a cash purchase price, a lease offer, and a discount off MSRP. The specials quality score still reflects the same missing five pieces of information that could improve the score of 78%, as the advertisements are based on the same information provided for the examples of FIGS. 4 and 5. Because multiple Google Adwords advertisements are created for the same vehicle Google Adwords can present the advertisement most directly related to the user's search to the user, resulting in greater user click-through and sales conversion than advertisements not tailored to a user's search.

For example, a user searching “2016 Ford Escape lease” will be presented with the second advertisement rather than the first or third shown in the window in the lower right, because that advertisement is most closely related to the user's search terms. That advertisement also provides information most directly relevant to the user's interests, and is the most likely to attract the user's attention and result in a sale.

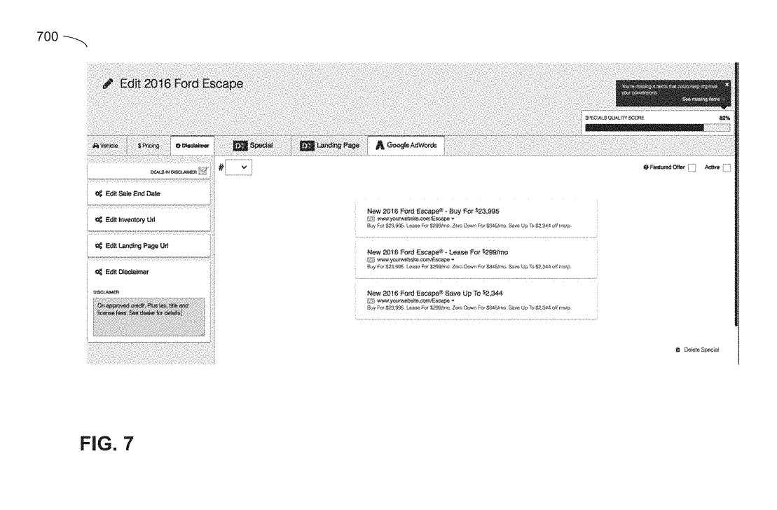

FIG. 7 is a dealer Google Adwords graphical user interface screen, in which disclaimer information is provided, improving the specials quality score. The screen image shown generally at 700 shows how entry of additional disclaimer text information provides one of the five missing items that could help improve conversions from FIG. 6, resulting in improvement of the specials quality score from 78% to 82% and a reduction in missing items from five to four. Although the disclaimer does not appear in the Google Adwords advertisements shown in the window on the lower right, the added information will be integrated into the specials advertisement and the landing page, thereby improving the overall quality score of the special.

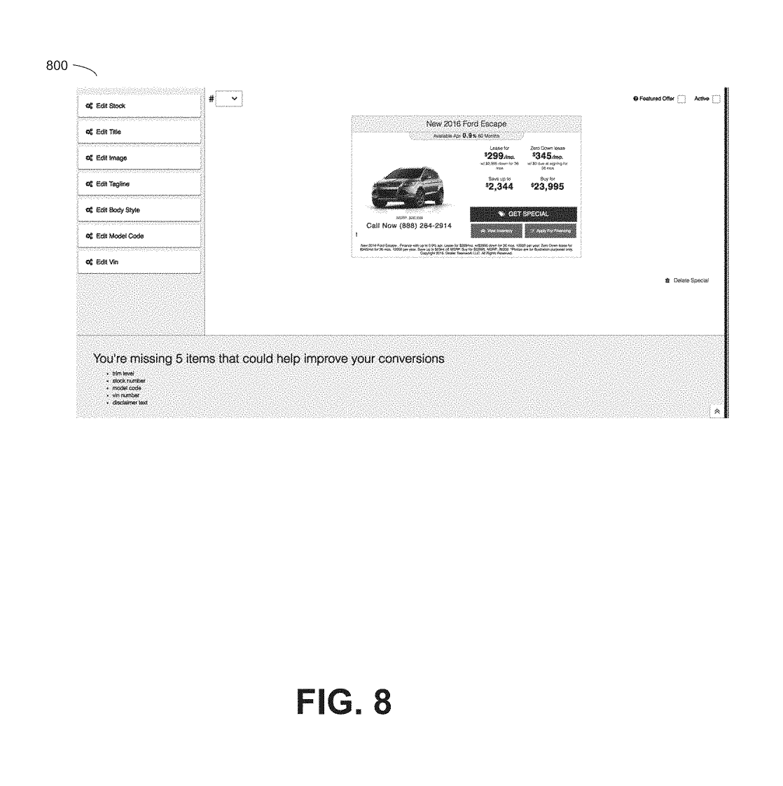

FIG. 8 is a specials quality score graphical user interface screen, which a dealer uses to provide additional information to improve the quality score of the special. As shown generally at 800, a dealer may click “see missing items” as displayed in the top right corner of the example screen shown in FIG. 6, resulting in display of the five items indicates as missing that could be provided to improve the specials quality score. These five items are listed in the bottom window of the screen, and include in this example trim level, stock number, model code, VIN number, and disclaimer text. The dealer in this example clicks disclaimer text, and is brought to the screen of FIG. 7 where disclaimer text can be entered to improve the quality score from 78% to 82%.

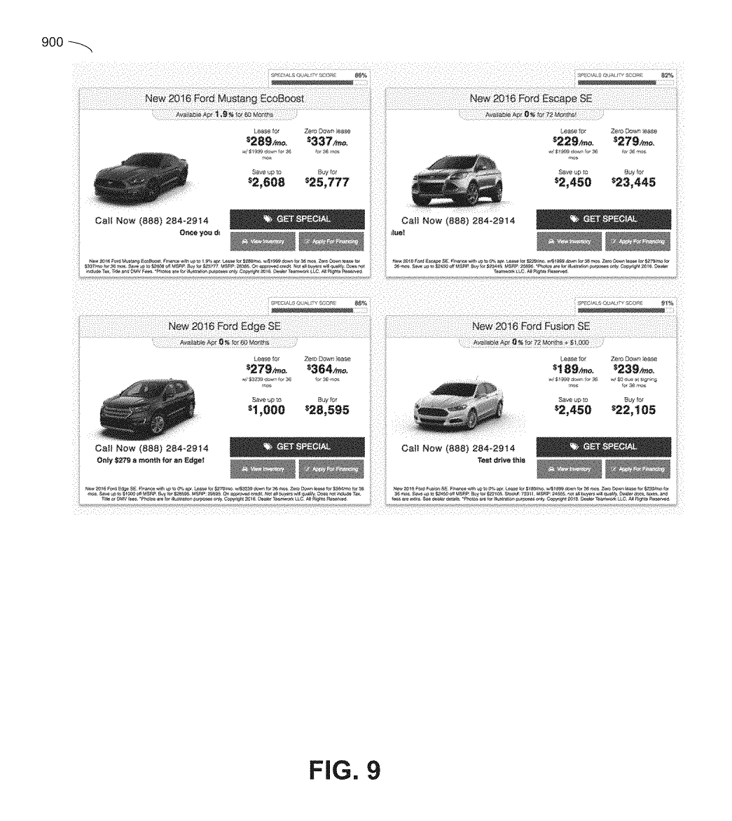

FIG. 9 is a screen image showing shows various specials the dealer has entered. As shown generally at 900, the dealer has entered special offers including a For Mustang, a Ford Escape, a Ford Edge SE, and a Ford Fusion SE. Offers displayed may be for different models, different trim lines, different options, or even for individual vehicles. This ensures that vehicles matching a user's preferences are available for display, and enables the advertising server to provide specials that are more closely related to a user's search query, click path, or other preferences. Each of the specials presented here includes information that can be used to construct a variety of offers for each vehicle, including savings off MSRP, cash price, zero down lease, standard lease with down payment, and interest rate for financing for a certain period of months.

The specials can be integrated into a dealer's stock listings on their website, and contain text that is fully searchable rather than the image text present in most modern vehicle advertisements. This enables search engines to find the relevant offer information from the specials, and index the information such that an offer relevant to a user's search terms will be high on the list of search results when a user searches for a vehicle to purchase.

In a further example, specials and advertisements are personalized to different users to a greater degree, such as including military discounts, student discounts, or other special offers to be presented to those who qualify. Specials may also vary by day, week, or month, or by other factors such as special events and holidays, such that the advertising system serves different advertisements or specials to users browsing the dealer's website during different periods. Because the advertising system can update the advertisements presented in real-time, the dealer is further able to offer specific vehicles for sale because the advertising system promptly removes the specific vehicle advertisement when the vehicle appears as sold in the dealer's vehicle inventory management system. Incentives also stay up-to-date, and are replaced automatically with current offers by the advertising system.

In some examples, the advertising system also provides the dealer with analytics regarding the effectiveness or various advertisements, specials, email campaigns, and the like, or provides data regarding such promotions to the dealer so that other analytics systems can be employed to improve the effectiveness of future advertising.

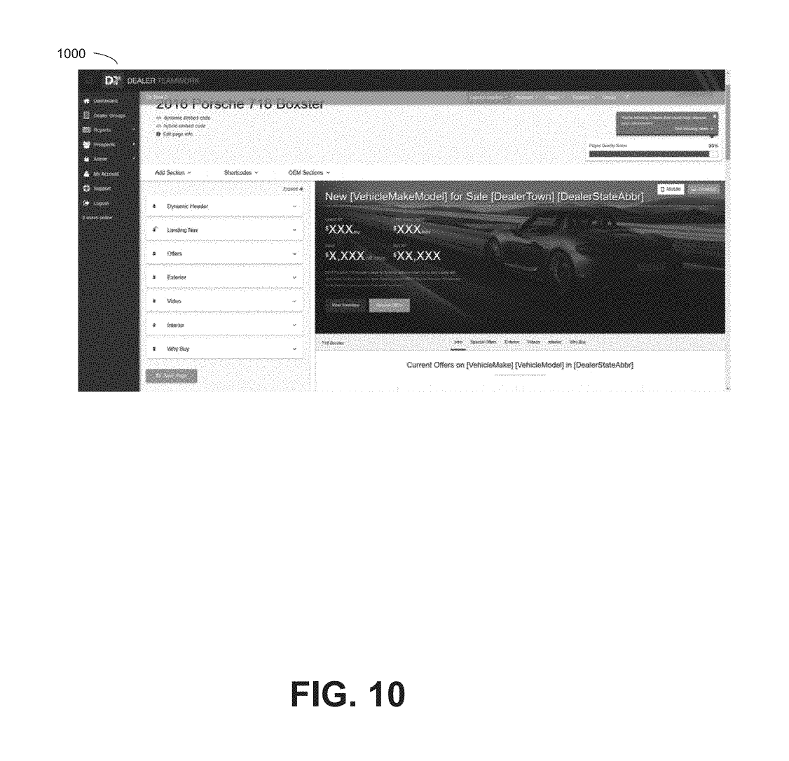

FIG. 10 shows a pages editor graphical user interface, which a dealer uses to edit a model page on the dealer website. As shown generally at 1000, the dealer is provided with a preconfigured model page for the vehicle selected, and can enter information such as page header, offers for the vehicle, exterior and interior images, video, and explanations as to why the user should buy the vehicle. Some of this information may be pre-populated for the dealer, while other information such as offers may be entered by the dealer to populate the vehicle page as shown in the lower right window on the screen image shown here. Prepopulated information includes in a further example information such as photos, trim levels, specifications, safety information, comparisons, etcetera. The menu bar at the top may be used to add additional sections to the page, to use shortcodes to populate key parts of the model page such as dealer name, phone number, and the like, and to retrieve OEM sections of the page such as required disclaimer, approved photos for a specific trim level, and the like.

The pages editor can further be used to update advertisements or specials meeting certain criteria, such as to update all photos of a Porsche Boxster to a new, approved photograph showing a certain trim level and options. The advertisement server is also operable in a further example to notify a dealer when new content is available, such as new photographs, and updated disclaimer, new videos featuring the vehicle model, and the like.

The vehicle page shown in the lower right window is in this example hosted by the advertising server (such as server 102 of FIG. 1), and is referenced by a pointer such as a javascript reference on the dealer website 128. Because it is undesirable for a blank page to be displayed if a user is able to retrieve information from the dealer's website 128 but not from advertising server 102, the dealer's website in a further example also includes static code showing a generic page for the vehicle should the vehicle page dynamically served from the advertising server not be available.

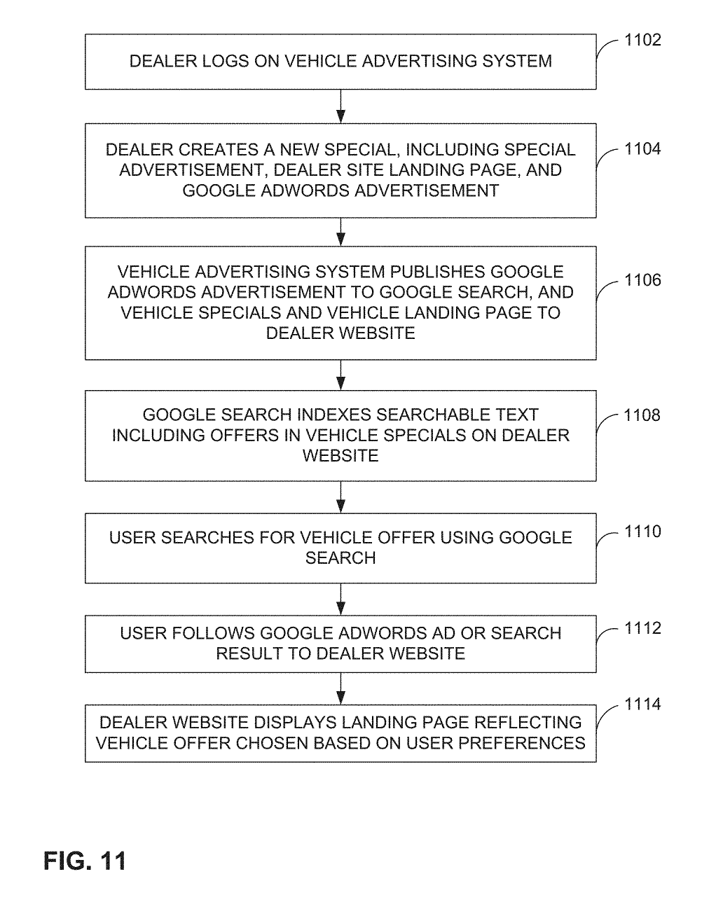

FIG. 11 is a flowchart, illustrating a method of presenting customer-specific dynamic vehicle advertising to a user. At 1102, a dealer starts building a vehicle special or advertisement offer for a vehicle by logging on to the vehicle advertising system. The dealer creates a new special at 1104, such as by entering information using a menu system using a graphical interface, or other means. The advertising system uses the entered information to populate different advertisements such as a special offer advertisement, a dealer website landing page, and a Google Adwords advertisement.

The vehicle advertising system publishes the Google Adwords advertisements to Google Adwords at 1106, and publishes vehicle special offer advertisements and vehicle landing pages to the dealer website at 1106. Publication of the special offer advertisements and vehicle landing pages comprises providing links to the advertisements on a vehicle advertising system in some examples, but in further examples includes static advertisements and pages.

Once the pages are published, Google is able to index the information in the special offer advertisements and landing pages on the dealer website at 1108, including various offers for each vehicle that may be relevant to a particular user. When a user searches for a particular vehicle for sale, such as “2016 Ford Escape lease,” the Google Adwords advertisement and the landing page or special offer most closely matching the user's search will be presented high in the search results, improving the likelihood that the user follows the link at 1112.

In response to the user following the link, the dealer website displays a landing page reflecting the vehicle offer at 1114, providing information about the vehicle, special offers for the vehicle, and other information to assist the user in finding the right offer for the desired vehicle.

These examples illustrate how a vehicle advertising system can work with a vehicle dealer web site to provide advertising, special offers, and other information tailored to a particular user based on the user's click path, search criteria, or other preferences to improve the likelihood that a user will find and take advantage of a particular offer matching the user's interests. Although many of the examples here deal with vehicle advertising, the principles discussed are readily applicable to other dealers and online marketplaces, such as vehicle parts or service, real estate, and other goods or services.

Vehicle parts, for example, are often sold at huge profit margins of 100% or more, but relatively few parts are sold. A dealer may wish to use an automated user targeted advertising system such as the examples described herein to target a higher volume of parts sales, online, dramatically increasing profitability of a parts department. Similarly, service departments have seven times as many transactions as vehicle sales departments, and maximizing the number of visits through intelligent offering of specials for various services is critical to ensuring a competitive and profitable service department.

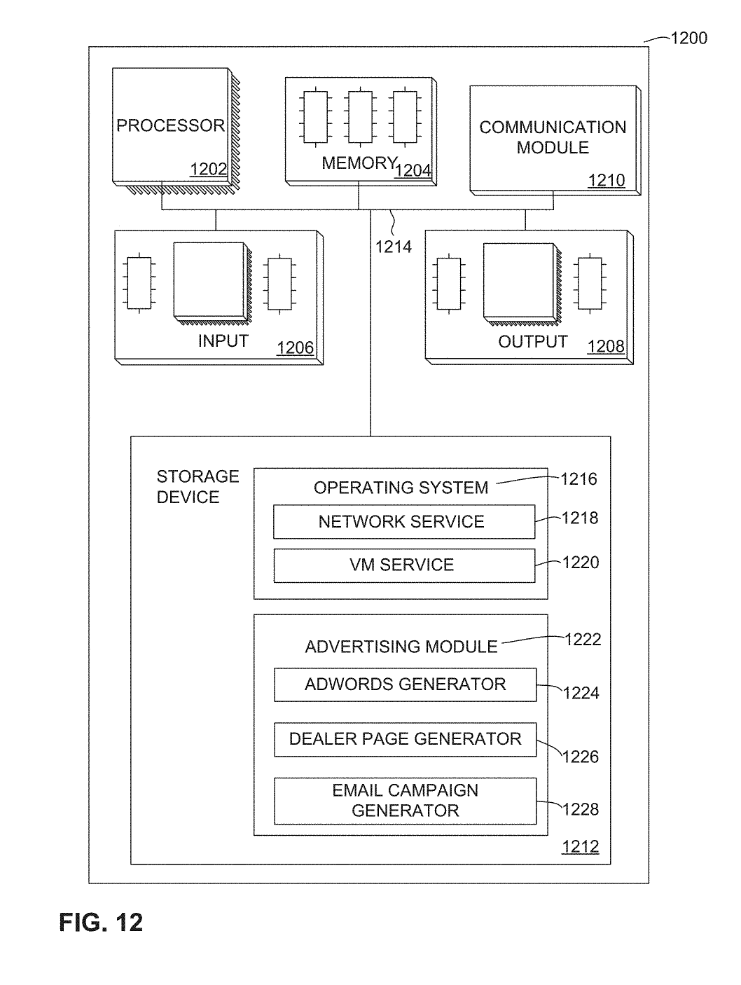

FIG. 12 shows a computerized online advertising system, as may be used to implement some of the examples described herein. FIG. 12 illustrates only one particular example of computing device 1200, and other computing devices 1200 may be used in other embodiments. Although computing device 1200 is shown as a standalone computing device, computing device 1200 may be any component or system that includes one or more processors or another suitable computing environment for executing software instructions in other examples, and need not include all of the elements shown here.

As shown in the specific example of FIG. 12, computing device 1200 includes one or more processors 1202, memory 1204, one or more input devices 1206, one or more output devices 1208, one or more communication modules 1210, and one or more storage devices 1212. Computing device 1200, in one example, further includes an operating system 1216 executable by computing device 1200. The operating system includes in various examples services such as a network service 1218 and a virtual machine service 1220. One or more applications, such as an advertising module 1222 are also stored on storage device 1212, and are executable by computing device 1200.

Each of components 1202, 1204, 1206, 1208, 1210, and 1212 may be interconnected (physically, communicatively, and/or operatively) for inter-component communications, such as via one or more communications channels 1214. In some examples, communication channels 1214 include a system bus, network connection, inter-processor communication network, or any other channel for communicating data. Applications such as advertising module 1222 and operating system 1216 may also communicate information with one another as well as with other components in computing device 1200.

Processors 1202, in one example, are configured to implement functionality and/or process instructions for execution within computing device 1200. For example, processors 1202 may be capable of processing instructions stored in storage device 1212 or memory 1204. Examples of processors 1202 include any one or more of a microprocessor, a controller, a digital signal processor (DSP), an application specific integrated circuit (ASIC), a field-programmable gate array (FPGA), or similar discrete or integrated logic circuitry.

One or more storage devices 1212 may be configured to store information within computing device 1200 during operation. Storage device 1212, in some examples, is known as a computer-readable storage medium. In some examples, storage device 1212 comprises temporary memory, meaning that a primary purpose of storage device 1212 is not long-term storage. Storage device 1212 in some examples includes a volatile memory, meaning that storage device 1212 does not maintain stored contents when computing device 1200 is turned off In other examples, data is loaded from storage device 1212 into memory 1204 during operation. Examples of volatile memories include random access memories (RAM), dynamic random access memories (DRAM), static random access memories (SRAM), and other forms of volatile memories known in the art. In some examples, storage device 212 is used to store program instructions for execution by processors 1202. Storage device 1212 and memory 1204, in various examples, are used by software or applications running on computing device 1200 such as advertising module 1222 to temporarily store information during program execution.

Storage device 1212, in some examples, includes one or more computer-readable storage media that may be configured to store larger amounts of information than volatile memory. Storage device 1212 may further be configured for long-term storage of information. In some examples, storage devices 1212 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 1200, in some examples, also includes one or more communication modules 1210. Computing device 1200 in one example uses communication module 1210 to communicate with external devices via one or more networks, such as one or more wireless or wired networks. Communication module 1210 may be a network interface card, such as an Ethernet card, an optical transceiver, a radio frequency transceiver, or any other type of device that can send and/or receive information. Other examples of such network interfaces include Bluetooth, cellular networks such as 3G, 4G, or LTE, WiFi radios, and Near-Field Communications (NFC), and Universal Serial Bus (USB). In some examples, computing device 1200 uses communication module 1210 to communicate with an external device such as via public network such as the Internet.

Computing device 1200 also includes in one example one or more input devices 1206. Input device 1206, in some examples, is configured to receive input from a user through tactile, audio, or video input. Examples of input device 1206 include a touchscreen display, a mouse, a keyboard, a voice responsive system, video camera, microphone or any other type of device for detecting input from a user.

One or more output devices 1208 may also be included in computing device 1200. Output device 1208, in some examples, is configured to provide output to a user using tactile, audio, or video stimuli. Output device 1208, in one example, includes a display, a sound card, a video graphics adapter card, or any other type of device for converting a signal into an appropriate form understandable to humans or machines. Additional examples of output device 1208 include a speaker, a light-emitting diode (LED) display, a liquid crystal display (LCD), or any other type of device that can generate output to a user.

Computing device 1200 may include operating system 1216, and various services such as network service 1218 and virtual machine service 1220. Operating system 1216, in some examples, controls the operation of components of computing device 1200, and provides an interface from various applications such as advertising module 1222 to components of computing device 1200. For example, operating system 1216, in one example, facilitates the communication of various applications such as advertising module 1222 with processors 1202, communication unit 1210, storage device 1212, input device 1206, and output device 1208. Applications such as advertising module 1222 may include program instructions and/or data that are executable by computing device 1200, and may receive, create, and store data. As one example, advertising module 1222 may include instructions that cause computing device 1200 to perform one or more of the operations and actions described in the examples presented herein, using Adwords generator 1224, dealer page generator 1226, and email campaign generator 1228 to perform the described functions.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A vehicle advertising system, comprising:
a processor configured to perform a an operation from among a predefined set of operations in response to receiving a corresponding instruction comprising part of an instruction set corresponding to the predefined set of operations;
a memory;
an advertisement generation module comprising:
a first set of instructions comprising instructions selected from the instruction set operable when executed on the processor to receive vehicle identification and vehicle financing information regarding a specific vehicle for sale;
a second set of instructions comprising instructions selected from the instruction set operable when executed on the processor to generate a first advertisement for the vehicle based on at least the received vehicle identification information and the received vehicle financing information, the first advertisement comprising an advertisement formatted for presentation in a search engine result listing;
a third set of instructions comprising instructions selected from the instruction set operable when executed on the processor to generate a second advertisement for the vehicle based on at least the received vehicle identification information and the received vehicle financing information, the second advertisement comprising an advertisement formatted for presentation on a vehicle dealer website; and
a fourth set of instructions comprising instructions selected from the instruction set operable when executed on the processor to provide a predicted effectiveness score on at least one of the first advertisement and the second advertisement before publication of the at least one advertisement, such that the advertiser is able to provide additional information to improve the predicted effectiveness score of the advertisement before publication and receive an updated predicted effectiveness score in response to the provided additional information;
wherein at least one of the first, second, third, and fourth sets of instructions are stored in the memory.

2. The vehicle advertising system of claim 1, wherein at least one of generating the first advertisement and generating the second advertisement comprises creating an HTML advertisement for the specific vehicle comprising information received from the dealer and having content that is indexable by a search engine, the advertisement created from dealer selection from a plurality of options including at least two of trim level, stock number, manufacturer's suggested retail price, savings off of manufacturer's suggested retail price, lease offer, zero down payment offer, annual percentage rate offer, and savings relative to a different offer.

3. The vehicle advertising system of claim 1, wherein the first advertisement comprises a Google AdWords advertisement that is automatically uploaded to Google AdWords.

4. The vehicle advertising system of claim 1, wherein the second advertisement comprises an HTML advertisement for a vehicle presented on a landing page from a search engine result listing.

5. The vehicle advertising system of claim 4, wherein the second advertisement presented on the landing page comprises content derived from at least one of search history of the user and click path that the user has followed.

6. The vehicle advertising system of claim 1, wherein at least one of the first advertisement and the second advertisement for the vehicle for sale redirect to an alternate vehicle if the vehicle for sale has been sold.

7. The vehicle advertising system of claim 1, further comprising a fifth set of instructions comprising instructions selected from the instruction set operable when executed on the processor to generate a third advertisement for the vehicle based on at least the received vehicle identification information and the received vehicle financing information, the third advertisement configured for inclusion in an email campaign.

8. The vehicle advertising system of claim 1, wherein at least one of the second set and third set of instructions are further operable when executed to use at least vehicle information or financing information from a remote computer system to prepare at least one of the first and second advertisements.

9. The vehicle advertising system of claim 1, wherein the second advertisement is configured for presentation using formatting specific to the user's platform or device.

10. A vehicle advertising system, comprising:
a processor configured to perform a an operation from among a predefined set of operations in response to receiving a corresponding instruction comprising part of an instruction set corresponding to the predefined set of operations;
a memory;
an advertisement generation module comprising:
a first set of instructions comprising instructions selected from the instruction set operable when executed on the processor to generate a vehicle advertisement configured to include likely customer search criteria;
a second set of instructions comprising instructions selected from the instruction set operable when executed on the processor to provide the advertisement for indexing by a search engine;
a third set of instructions comprising instructions selected from the instruction set operable when executed on the processor to create a landing page in response to a customer selecting a search result in the search engine, the created landing page comprising an advertisement for a vehicle selected based on at least one of search history of the user and click path that the user has followed; and
a fourth set of instructions comprising instructions selected from the instruction set operable when executed on the processor to presenting the landing page to the customer in response to the customer selecting the search result;
wherein at least one of the first, second, third, and fourth sets of instructions are stored in the memory.

11. The vehicle advertising system of claim 10, wherein created landing page comprising an advertisement for a vehicle comprises including at least two of trim level, stock number, manufacturer's suggested retail price, savings off of manufacturer's suggested retail price, lease offer, zero down payment offer, annual percentage rate offer, and savings relative to a different offer based on the at least one of search history of the user and click path that the user has followed.

12. The vehicle advertising system of claim 10, wherein advertisement for a vehicle redirects to an alternate vehicle if the advertised vehicle has been sold.

13. A vehicle advertising system, comprising:
a processor configured to perform a an operation from among a predefined set of operations in response to receiving a corresponding instruction comprising part of an instruction set corresponding to the predefined set of operations;
a memory;
an advertisement generation module comprising:
a first set of instructions comprising instructions selected from the instruction set operable when executed on the processor to receive vehicle information from a dealer about a specific vehicle for which the dealer desires to create an advertisement;
a second set of instructions comprising instructions selected from the instruction set operable when executed on the processor to create an HTML advertisement for the specific vehicle comprising information received from the dealer and having content that is indexable by a search engine, the advertisement created from dealer selection from a plurality of options including at least two of trim level, stock number, manufacturer's suggested retail price, savings off of manufacturer's suggested retail price, lease offer, zero down payment offer, annual percentage rate offer, and savings relative to a different offer;
wherein at least one of the first and second sets of instructions are stored in the memory.

14. The vehicle advertising system of claim 13, further comprising a third set of instructions comprising instructions selected from the instruction set operable when executed on the processor to provide a predicted effectiveness score on at least one of the first advertisement and the second advertisement before publication of the at least one advertisement, such that the advertiser is able to provide additional information to improve the predicted effectiveness score of the advertisement before publication and receive an updated predicted effectiveness score in response to the provided additional information.

15. The vehicle advertising system of claim 13, wherein the HTML advertisement comprises an HTML advertisement for a vehicle presented on a landing page from a search engine result listing.

16. The vehicle advertising system of claim 15, wherein the HTML advertisement presented on the landing page comprises content derived from at least one of search history of the user and click path that the user has followed.

17. The vehicle advertising system of claim 13, wherein HTML advertisement for the vehicle for sale redirects to an alternate vehicle if the vehicle for sale has been sold.

18. The vehicle advertising system of claim 13, wherein the second set of instructions is further operable when executed to use at least vehicle information or financing information from a remote computer system to prepare the HTML advertisement.

19. A vehicle advertising system, comprising:
a processor configured to perform a an operation from among a predefined set of operations in response to receiving a corresponding instruction comprising part of an instruction set corresponding to the predefined set of operations;
a memory;
an advertisement generation module comprising:
a first set of instructions comprising instructions selected from the instruction set operable when executed on the processor to receive vehicle identification and vehicle financing information regarding a specific vehicle for sale;
a second set of instructions comprising instructions selected from the instruction set operable when executed on the processor to generate a first advertisement for the vehicle based on at least the received vehicle identification information and the received vehicle financing information, the first advertisement comprising an advertisement formatted for presentation on a vehicle dealer website; and
a third set of instructions comprising instructions selected from the instruction set operable when executed on the processor to provide a predicted effectiveness score on the first advertisement before publication of the first advertisement, such that the advertiser is able to provide additional information to improve the predicted effectiveness score of the advertisement before publication and receive an updated predicted effectiveness score in response to the provided additional information, the instructions further operable to prevent publication of the first advertisement until the predicted effectiveness score reaches a predetermined threshold;
wherein at least one of the first, second, and third sets of instructions are stored in the memory.

20. A vehicle advertising system, comprising:
a processor configured to perform a an operation from among a predefined set of operations in response to receiving a corresponding instruction comprising part of an instruction set corresponding to the predefined set of operations;
a memory;
an advertisement generation module comprising:
a first set of instructions comprising instructions selected from the instruction set operable when executed on the processor to receive information regarding a specific used vehicle, vehicle service, or vehicle part or parts for sale;
a second set of instructions comprising instructions selected from the instruction set operable when executed on the processor to generate a first advertisement for the specific used vehicle, vehicle service, or vehicle part or parts based on at least the received information, the first advertisement comprising an advertisement formatted for presentation in a search engine result listing;
a third set of instructions comprising instructions selected from the instruction set operable when executed on the processor to generate a second advertisement for the specific used vehicle, vehicle service, or vehicle part or parts based on at least the received information, the second advertisement comprising an advertisement formatted for presentation on a vehicle dealer website; and
a fourth set of instructions comprising instructions selected from the instruction set operable when executed on the processor to providing a predicted effectiveness score on at least one of the first advertisement and the second advertisement before publication of the at least one advertisement, such that the advertiser is able to provide additional information to improve the predicted effectiveness score of the advertisement before publication and receive an updated predicted effectiveness score in response to the provided additional information;
wherein at least one of the first, second, third, and fourth sets of instructions are stored in the memory.

21. A vehicle advertising system, comprising:
a processor configured to perform a an operation from among a predefined set of operations in response to receiving a corresponding instruction comprising part of an instruction set corresponding to the predefined set of operations;
a memory;
an advertisement generation module comprising:
a first set of instructions comprising instructions selected from the instruction set operable when executed on the processor to generate a vehicle advertisement configured to include likely customer search criteria;
a second set of instructions comprising instructions selected from the instruction set operable when executed on the processor to provide the advertisement for indexing by a search engine;
a third set of instructions comprising instructions selected from the instruction set operable when executed on the processor to create a landing page in response to a customer selecting a search result in the search engine, the created landing page comprising an advertisement for a vehicle selected based on at least one of search history of the user and click path that the user has followed; and
a fourth set of instructions comprising instructions selected from the instruction set operable when executed on the processor to presenting the landing page to the customer in response to the customer selecting the search result;
wherein at least one of the first, second, third, and fourth sets of instructions are stored in the memory.
